(19) United States
(12) Patent Application Publication
(10) Pub. No.: US 2012/0249599 A1
(43) Pub. Date: Oct. 4, 2012

(54) METHOD OF IDENTIFYING A MULTI-TOUCH SCALING GESTURE AND DEVICE USING THE SAME

(75) Inventors: Tiejun Cai, Shenzhen (CN); Lianfang Yi, Shenzhen (CN); Zhibin Chen, Shenzhen (CN); Bangjun He, Shenzhen (CN); Yun Yang, Shenzhen (CN)

(73) Assignee: BYD COMPANY LIMITED, Shenzhen (CN)

(21) Appl. No.: 13/354,867

(22) Filed: Jan. 20, 2012

(30) Foreign Application Priority Data
Mar. 31, 2011 (CN) 201110080827.4

(51) Int. Cl. G09G 5/00

(52) U.S. Cl. 345/661

(57) ABSTRACT

A method of identifying a scaling gesture comprises detecting one or more induction signals induced by one or more pointing objects that come into contact with a touch-sensitive surface, determining the number of the pointing object, determining a scaling gesture, generating a control signal associated with the determined scaling gesture and executing the scaling gesture in response to the generated control signal.

### CROSS-REFERENCE TO RELATED APPLICATION

This application claims priority under 35 U.S.C.§119 to Chinese Patent Application No. 201110080827.4, filed on Mar. 31, 2011, the content of which is incorporated herein by reference in its entirety.

### TECHNICAL FIELD

Example embodiments of the present disclosure relate generally to a method of identifying gestures on a touchpad, and more particularly, to a method of identifying a scaling gesture and device thereof.

### BACKGROUND

Although the keyboard remains a primary input device of a computer, the prevalence of graphical user interfaces (GUIs) may require use of a mouse or other pointing device such as a trackball, joystick, touch device or the like. Due to its compact size, the touch device has become popular and widely used in various areas of our daily lives, such as mobile phones, media players, navigation systems, digital cameras, digital cameras, digital photo frame, personal digital assistance (PDA), gaming devices, monitors, electrical control, medical equipment and so on.

A touch device features a sensing surface that can translate the motion and position of a user's fingers to a relative position on screen. Touchpads operate in one of several ways. The most common technology includes sensing the capacitive virtual ground effect of a finger, or the capacitance between sensors. For example, by independently measuring the self-capacitance of each X and Y axis electrode on a sensor, the determination of the (X, Y) location of a single touch is provided.

### SUMMARY

According to one exemplary embodiment of the present invention, a method of identifying multi-touch scaling gesture comprises detecting one or more induction signals induced by one or more pointing objects that come into contact with a touch-sensitive surface; determining the number of the pointing object; determining whether the pointing object performs a scaling gesture; generating a control signal associated with the determined scaling gesture; and executing the scaling gesture in response to the generated control signal.

According to one exemplary embodiment of the present invention, a device of identifying multi-touch points comprises a detecting module, configured to detect one or more induction signals induced by one or more pointing objects that come into contact with a touch-sensitive surface; a determination module, configured to determine the number of pointing objects; a scaling gesture determining module, configured to detect movement statuses of the detected pointing objects and determine a scaling gesture performed by the pointing objects based on the movement statuses; a signal generation module, configured to generate a control signal associated with the determined scaling gesture; and a processing unit, configured to execute the scaling gesture in response to the generated control signal.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a block diagram of an scaling gesture identifying device according to one exemplary embodiment of the present invention;

FIG. 2 illustrates a schematic diagram of a touch-sensitive surface according to one exemplary embodiment of the present invention;

FIG. 3 illustrates a block diagram of a determination module according to one exemplary embodiment of the present invention;

FIG. 4 illustrates a block diagram of a scaling gesture determining module according to one exemplary embodiment of the present invention;

FIG. 5 illustrates a method of identifying a scaling gesture according to one exemplary embodiment of the present invention;

FIG. 6 illustrates a method of identifying the number of pointing objects that contact the touch screen according to one exemplary embodiment of the present invention;

FIGS. 7-9 illustrate diagrams of a detected induction signal and a reference signal according to exemplary embodiments of the present invention; and

FIGS. 10-13 illustrate schematic diagrams of scaling gestures according to exemplary embodiments of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In this regard, although example embodiments may be described herein in the context of a touch screen or touch-screen panel, it should be understood that example embodiments are equally applicable to any of a number of different types of touch-sensitive surfaces, including those with and without an integral display (e.g., touchpad). Also, for example, references may be made herein to axes, directions and orientations including X-axis, Y-axis, vertical, horizontal, diagonal, right and/or left; it should be understood, however, that any direction and orientation references are simply examples and that any particular direction or orientation may depend on the particular object, and/or the orientation of the particular object, with which the direction or orientation reference is made. Like numbers refer to like elements throughout.

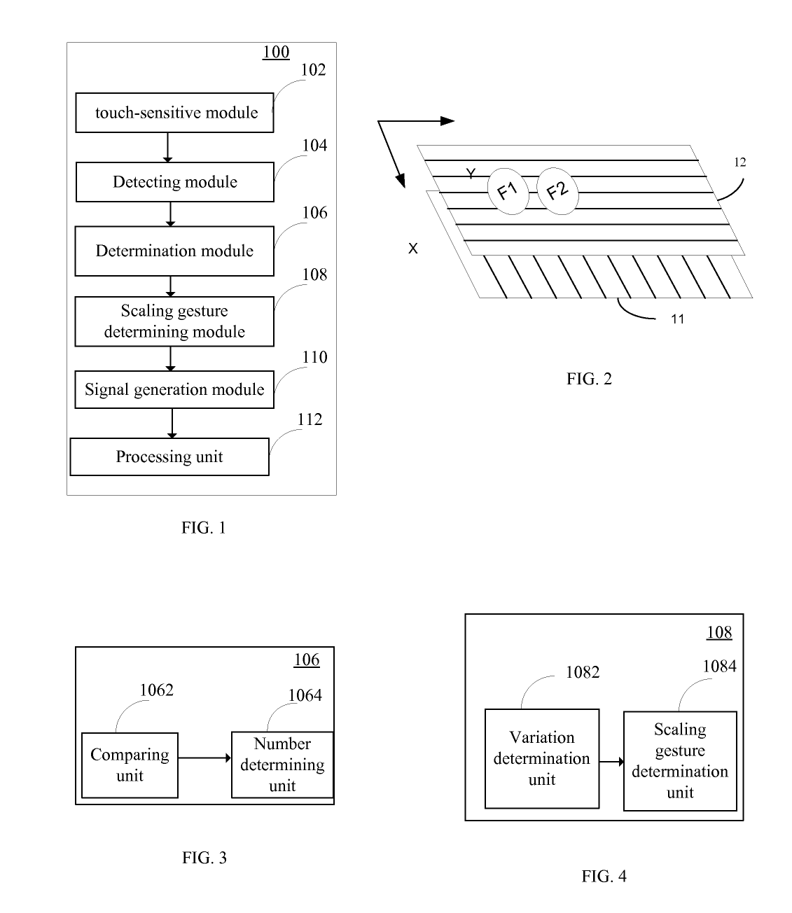

FIG. 1 illustrates a schematic diagram of a device of identifying a scaling gesture 100 according to an exemplary embodiment of the present invention (“exemplary” as used herein referring to “serving as an example, instance or illustration”). As explained below, the device of identifying a scaling gesture 100 may be configured to determine a gesture and generate corresponding control signals based on coordinates of multi-touch points on a touch screen. The device of identifying a scaling gesture 100 may be configured to provide the control signals and other related information to a processing unit of a terminal application device to execute the gesture applied to the touch screen. The terminal application device may be any of a number of different processing devices including, for example, a laptop computer, desktop computer, server computer, or a portable electronic devices such as a portable music player, mobile telephone, portable digital assistant (PDA), tablet or the like. Generally, the terminal application device may include the processing unit, memory, user interface (e.g., display and/or user input interface) and/or one or more communication interfaces. The touch screen may be a resistive touch screen, a capacitive touch screen, an infrared touch screen, an optical imaging touch screen, an acoustic pulse touch screen, surface acoustic touch screen or in any other forms.

As illustrated in FIG. 1, the device of identifying a scaling gesture 100 may include a touch-sensitive module 102, a detecting module 104, a determination module 106, a scaling gesture determining module 108, a signal generation module 110 and a processing unit 112. The touch-sensitive module 102 of one example may be as illustrated in FIG. 2. The determination module 106 may include a comparing unit 1062 and a number determining unit 1064 as illustrated in FIG. 3. The scaling gesture determining module 108 may include a variation determination unit 1082 and a scaling gesture determination unit 1084 as illustrated in FIG. 4. The processing unit 112 may execute a scaling command in response to the generated control signal.

FIG. 2 illustrates a schematic diagram of a touch-sensitive surface according to one exemplary embodiment of the present invention. The touch-sensitive module 102 may include a plurality of inductive lines 11 and 12 on respective X and Y axes to form the touch-sensitive surface. In other exemplary embodiments, the touch-sensitive module 102 may comprise an acoustic sensor, optical sensor or other kind of sensor to form a touch-sensitive surface for sensing the touch by the pointing objects. The X and Y axes may be perpendicular to each other, or have a specific angle other than 90°. As also shown, F1 and F2 indicate two touch points on the touch-sensitive module 102 by two pointing objects according to an exemplary embodiment. The touch-sensitive module 102 may be embodied in a number of different manners forming an appropriate touch-sensitive surface, such as in the form of various touch screens, touchpads or the like. As used herein, then, reference may be made to the touch-sensitive module 102 or a touch-sensitive surface (e.g., touch screen) formed by the touch-sensitive module. In some embodiment of the present invention, the touch-sensitive module 102 may comprises inductive lines in other direction.

In operation, when a pointing object, such as a user's finger or a stylus is placed on the touch screen, the touch-sensitive module 102 may generate one or more induction signals induced by the pointing object. The generated induction signals may be associated with a change in electrical current, capacitance, acoustic waves, electrostatic field, optical fields or infrared light. The detecting module 104 may detect the induction signals associated with the change induced by one or more pointing objects, such as two pointing objects in one or more directions on the touch screen. In an instance in which two pointing objects are simultaneously applied to the touch screen, the comparing unit 1062 may compare value of each point of the induction signal to a reference signal to determine if it is a rising wave or a falling wave and further determine the number of rising waves and the number of falling waves. The number determining unit 1064 may determine the number of pointing objects according to the number of rising waves and the number of falling waves. The determination module 106 may then output what is obtained by the number determining unit 1064 to the scaling gesture determining module 108.

In one exemplary embodiment, there may be a plurality of pointing objects in contact with the touch screen. The variation determination unit 1084 may obtain relative movements of each pointing object. In an instance, the variation determination unit may obtain coordinates of a first start touch point and a first end touch point of the pointing objects. Based on the result obtained by the variation determination unit 1084, the scaling gesture determination unit 1086 may determine whether the pointing objects perform a scaling gesture. The signal generation module 110 may generate corresponding control signals. The processing unit 112 may be configured to interact with the terminal application device based on the control signals, such as by executing a scaling on a display of the terminal application device.

As described herein, the touch-sensitive module 102 and the processing unit 112 are implemented in hardware, alone or in combination with software or firmware. Similarly, the detecting module 104, determination module 106, the scaling gesture determination module 108 and the signal generation module 110 may each be implemented in hardware, software or firmware, or some combination of hardware, software and/or firmware. As hardware, the respective components may be embodied in a number of different manners, such as one or more CPUs (Central Processing Units), microprocessors, coprocessors, controllers and/or various other hardware devices including integrated circuits such as ASICs (Application Specification Integrated Circuits), FPGAs (Field Programmable Gate Arrays) or the like. As will be appreciated, the hardware may include or otherwise be configured to communicate with memory, such as volatile memory and/or non-volatile memory, which may store data received or calculated by the hardware, and may also store one or more software or firmware applications, instructions or the like for the hardware to perform functions associated with operation of the device in accordance with exemplary embodiments of the present invention.

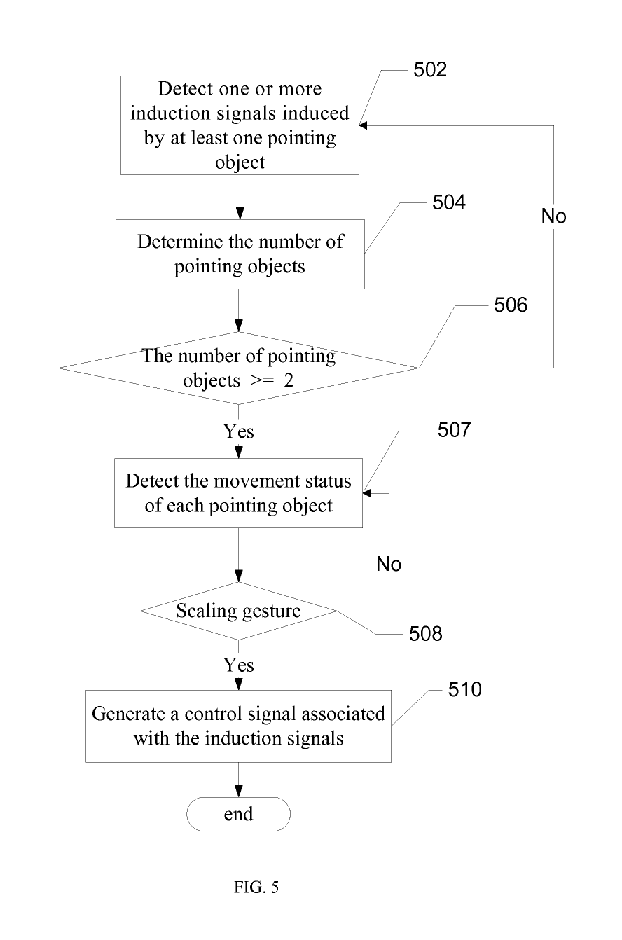

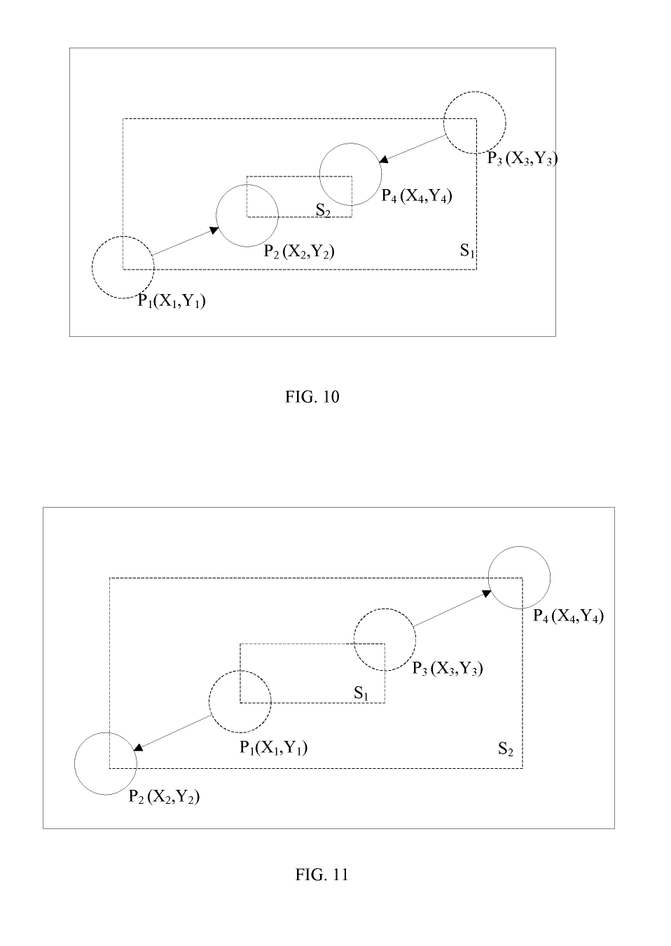

FIG. 5 illustrates various steps in a method of identifying a scaling gesture according to one exemplary embodiment of the present invention. When a pointing object, such as a finger, comes into contact with the touch screen at a touch point, the touch-sensitive module 102 may sense the contact and generate one or more induction signals. The detecting module 104 may detect the induction signals induced by the pointing object at step 502. In an instance in which two or more pointing objects are simultaneously applied to the touch screen, the number of the pointing objects may be obtained by the determination module 106 at step 504. In an instance in which the number of pointing objects is determined to be larger than or equal to two at step 506, the scaling gesture determining module 108 may determine the moving statuses of each pointing object at step 507. In some instances in which the gesture is determined as a scaling gesture at step 508, a control signal associated with the detected induction signals are generated at step 510. An operation associated with the generated control signal may be executed by the processing unit 112. In an instance in which the number of the pointing objects is less than 2, the device of identifying a scaling gesture 100 may await and detect a next induction signal induced by one or more pointing objects at step 502. In an instance in which the gesture applied to the touch screen may not be a scaling gesture at step 508, the device of identifying a scaling gesture 100 may continue to detect and determine the moving statuses of the pointing objects at step 507. When the moving statuses of each pointing object satisfy the conditions set at step 508, it is determined as a scaling gesture which is described in detail with reference to FIGS. 10-13. The method proceeds to generate associated control signals.

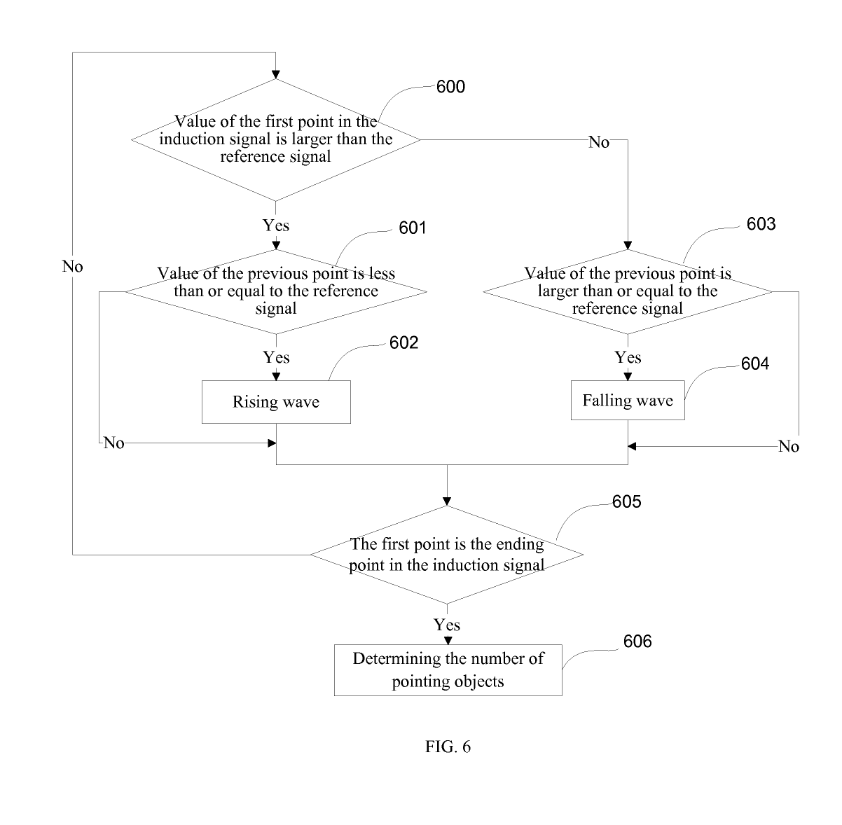

FIG. 6 illustrates a method of determining the number of pointing objects that contact the touch screen according to one exemplary embodiment of the present invention. When at least one pointing object is in contact with the touch screen, an induction signal sensed and generated by the touch-sensitive module 102 may be detected by the detecting module 104.

At step 600, value of a first point of the induction signal is compared to a reference signal by the comparing unit 1062. In an instance in which the value of the first point is larger than the reference signal, value of a previous point of the induction signal is compared to the reference signal by the comparing unit 1062. In an instance in which the value of the previous point is less than or equal to the reference signal at step 601, the wave is determined as a rising wave at step 602. In an instance in which the value of the previous point is larger than or equal to the reference signal, the determination module 106 may determine if the first point is the last point in the induction signal at step 605. If it is determined as the last point, the number of pointing objects may be determined at step 606 based on the number of rising waves and/or the number of falling waves and may be output by the number determining unit 1064 to the scaling gesture determining module 108.

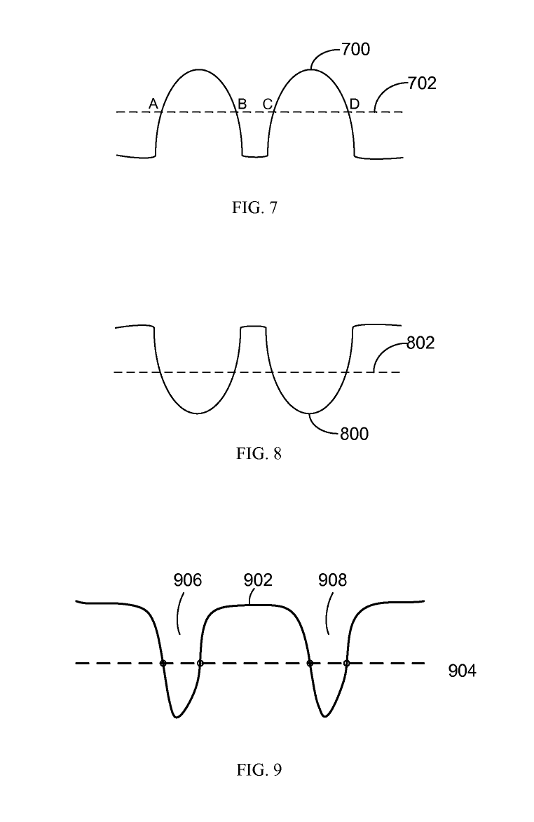

In an instance in which the value of the first point is less than the reference signal at step 600, value of the previous point in the induction signal is compared to the reference signal at step 603. In an instance in which the value of the previous point is larger than or equal to the reference signal, the wave is determined as a falling wave at step 604. The process may proceed to step 605 to determine if the first point is the last point in the induction signal. In an instance in which the first point is not the last point in the induction signal at step 605, the process may otherwise proceed to select a next point and compare value of the next point to the reference signal at step 600. If it is determined as the last point, the number of pointing objects may be determined at step 606 based on the number of rising waves and/or the number of falling waves and may be output by the number determining unit 1064 to the scaling gesture determining module 108. In an exemplary embodiment, the number of the pointing objects is determined according to the maximum number of rising waves or falling waves of the first induction signal or the second induction signal. In an exemplary embodiment, if the number of the rising waves is not equal to that of the falling waves, the process may await next induction signals. In one exemplary embodiment, a first initial induction value and a second initial induction value may be predetermined. In the exemplary embodiment as illustrated in FIG. 7, the first initial induction value and the second initial induction value are predetermined less than the reference signal. In another exemplary embodiment as illustrated in FIG. 8, the first initial induction value and the second initial induction value are predetermined larger than the reference signal. The first initial induction value is preceding the first point of the detected induction signal and the last point of the detected signal is preceding the second initial induction value. In this manner, the value of the first point of the detected induction signal and the predetermined first initial induction value may be compared with the reference signal. The predetermined second initial induction value and the value of the last point of the detected signal may be compared with the reference signal.

FIG. 7 illustrates a diagram of a detected induction signal 700 and a reference signal 702 according to one exemplary embodiment of the present invention. In an instance in which a pointing object comes into contact with the touch screen at a touch point, the contact at that touch point may induce the touch-sensitive module 102 to generate the induction signal 700. Accordingly, the number of rising waves or the number of falling waves may corresponds to the number of pointing objects that are in contact with the touch screen. The rising wave may cross the reference signal at points A and C (referred as “rising point”). The falling wave may cross the reference signal at points B and D (referred as “drop point”). Due to some unexpected noises, the induction signal may not be induced by a valid contact of a pointing object. To determine whether an induction signal induced by a valid contact, the distance between one rising point and a subsequent drop point may be measured and compared to a predetermined threshold value by the comparing unit 1062. If the distance is larger than the predetermined threshold value, the induction signal is determined to be induced by a valid touch. For example, the distance between the rising point A and its subsequent drop point B may be measured and compared to a predetermined threshold value.

Different induction signal waves may be obtained due to different analyzing methods or processing methods. FIG. 8 illustrates an induction signal 800 induced by a contact with the touch screen and a reference signal 802 according to an exemplary embodiment. The method of determining a valid contact at a touch point and the number of touch points may be similar to that is described above. To determine whether an induction signal induced by a valid contact, the distance between one drop point and a subsequent rising point may be measured and compared to a predetermined threshold value by the comparing unit 1062. If the distance is larger than the predetermined threshold value, the induction signal is determined to be induced by a valid touch.

Touch points may be determined by measuring the attenuation of waves, such as ultrasonic waves, across the surface of the touch screen. For instance, the processing unit may send a first electrical signal to a transmitting transducer. The transmitting transducer may convert the first electrical signal into ultrasonic waves and emit the ultrasonic waves to reflectors. The reflectors may refract the ultrasonic waves to a receiving transducer. The receiving transducer may convert the ultrasonic waves into a second electrical signal and send it back to the processing unit. When a pointing object touches the touch screen, a part of the ultrasonic wave may be absorbed causing a touch event that may be detected by the detecting module 104 at that touch point. Coordinates of the touch point are then determined. An attenuated induction signal 902 crossed by a reference signal 904 and two attenuation parts 906 and 908 are illustrated in FIG. 9.

FIGS. 10-13 illustrate schematic diagrams of scaling gestures according to exemplary embodiments of the present invention. There may be a plurality of pointing objects that simultaneously come into contact with the touch screen to perform a gesture, and which pointing objects may induce a plurality of detectable induction signals. In the embodiments illustrated in FIGS. 10-13, two pointing objects come into contact with the touch screen. Each of the pointing objects may move from a start touch point to an end touch point. To determine whether the pointing objects perform a scaling gesture, coordinates (X₁, Y₁) of a start touch point P₁ and (X₂, Y₂) of an end touch point P₂ associated with the first pointing object, and (X₃, Y₃) of a start touch point P₃ and (X₄, Y₄) of an end touch point P₄ associated with the second pointing object may be recorded by the variation determination unit 1082 of the scaling gesture determining module 108. For convenience and brevity, the start points P₁ and P₃ of the first and second pointing objects are defined as diagonal points of a first rectangular area S₁. The end points P₂ and P₄ are defined as diagonal points of a second rectangular area S₂. In an instance in which the first area S₁ is greater than the second area S₂, i.e., (X₃−X₁)*(Y₃−Y₁)>(X₄−X₂)*(Y₄−Y₂), as illustrated in FIG. 10, the operation is determined as a scaling down gesture by the scaling gesture determination unit 1084 of the scaling gesture determining module 108. In an instance in which the first area S₁ is less than the second area S₂, i.e., (X₃−X₁)*(Y₃−Y₁)<(X₄−X₂)*(Y₄−Y₂), as illustrated in FIG. 11, the operation is determined as a scaling up gesture. In some exemplary embodiments, if difference in X-axis (e.g., X₄−X₂, X₃−X₁,) or difference in Y-axis (Y₃−Y₁, Y₄−Y₂) between the start touch points P₁ and P₃ or between the end touch points P₂ and P₄ is less than 1, the difference is set to 1. The difference between the first area S₁ and the second area S₂ or between the coordinates of the start touch points and those of the end touch points in X-axis or Y-axis may be equal to or proportional to the scale gesture that is executed on the touch screen.

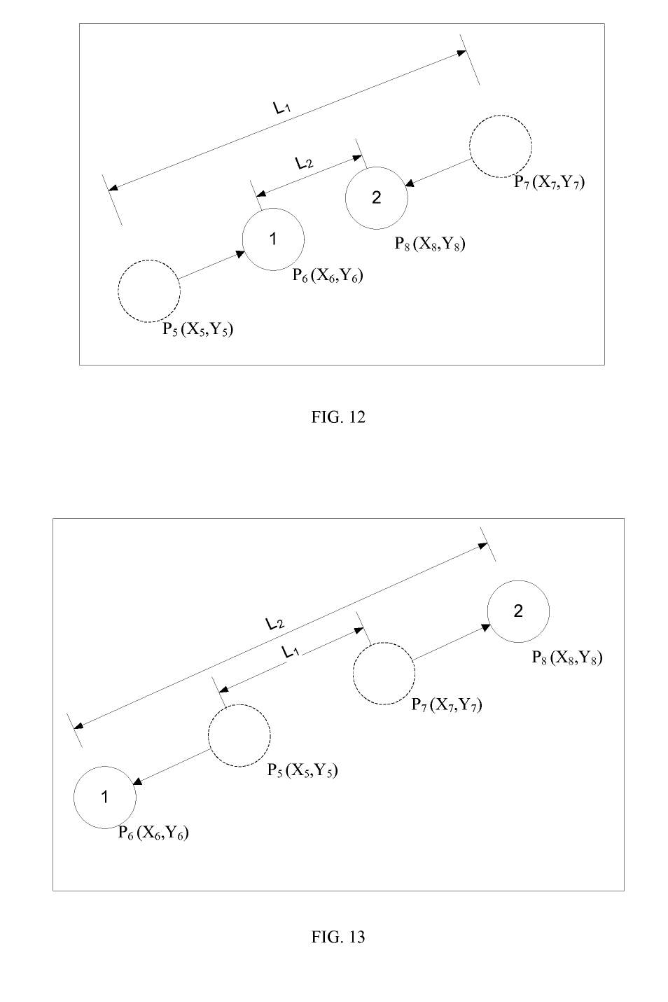

Whether a scaling gesture is applied to the touch screen may be determined by various methods. As shown in FIGS. 12 and 13, the scaling gesture may be determined according to the variation of the distance between the start touch points and the end touch points associated with two pointing objects. As shown in FIG. 12, coordinates (X₅, Y₅) of a start touch point P₅ and (X₆, Y₆) of an end touch point P₆ associated with the first pointing object, and (X₇, Y₇) of a start touch point P₇ and (X₈, Y₈) of an end touch point P₈ associated with the second pointing object may be recorded by the variation determination unit 1082 of the scaling gesture determining module 108. A first distance L₁=\sqrt{(X₁−X₂)²+(Y₁−Y₂)²} between the start touch points P₅ and P₇ is compared to a second distance L₂=\sqrt{(X′₁−X′₂)²+(Y′₁−Y′₂)²} between the end touch point P₆ and P₈. In an instance in which the first distance is greater than the second distance, i.e., L₁>L₂ as shown in FIG. 12, the operation is determined as a scaling down gesture. In an instance in which the first distance is less than the second distance, i.e., L₁<L₂ as shown in FIG. 13, the operation is determined as a scaling up gesture. A scaling factor may be determined according to the difference between the first distance and the second distance.

All or a portion of the system of the present invention, such as all or portions of the aforementioned processing unit and/or one or more modules of the device of identifying a scaling gesture 100, may generally operate under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method of identifying a scaling gesture comprising:
detecting one or more induction signals induced by one or more pointing objects that come into contact with a touch-sensitive surface;
determining the number of the pointing objects that come into contact with a touch screen;
determining a scaling gesture performed by the pointing objects;
generating a control signal associated with the determined scaling gesture; and
executing a scaling command in response to the generated control signal.

2. The method of claim 1, wherein determining the number of pointing objects comprises:
selecting a first point and a second point of each detected induction signal, the second point preceding the first point;
comparing values of the two selected points to a reference signal to determine a rising wave or a falling wave; and
determining the number of rising waves and/or falling waves to determine the number of pointing objects.

3. The method of claim 2, wherein comparing values comprises:
comparing a first value of the first point to the reference signal;
comparing a second value of the second point to the reference signal; and
determining a rising wave or a falling wave according to the comparison results.

4. The method of claim 3 further comprising:
identifying one or more rising points on the rising wave intercepted by the reference signal;
identifying one or more drop points on the falling wave intercepted by the reference signal; and
comparing a distance between a rising point and a subsequent drop point to a predetermined threshold value or comparing a distance between a drop point and a subsequent rising point to a predetermined threshold value to determine if the detected induction signal is induced by a valid contact.

5. The method of claim 4, further comprising:
detecting a first induction signal in a first direction; and
detecting a second induction signal in a second direction, wherein the first direction and the second direction have an angel therebetween.

6. The method of claim 4, furthering comprising:
determining the number of the pointing objects according to the number of rising waves or falling waves of the first induction signal or the second induction signal.

7. The method of claim 1, wherein the pointing objects come into contact with the touch-sensitive surface at respective touch points, and wherein the method further comprises:
obtaining coordinates of a first start touch point and a first end touch point associated with a first pointing object, and a second start touch point and a second touch end point associated with a second pointing object; and
determining a scaling gesture based on the obtained coordinates.

8. The method of claim 7, further comprises:
obtaining a first area of a first rectangular with the first start touch point and the second start touch point on diagonal corners of the first rectangular;
obtaining a second area of a second rectangular with the first end touch point and the second end touch point on diagonal corners of the second rectangular; and
comparing the first area to the second area; and
determining a scaling gesture based on the comparison result.

9. The method of claim 8, further comprising:
setting the difference to 1 in an instance in which difference between coordinates in one direction between the first start touch point and the second start touch point is less than 1 or difference between coordinates in one direction between the first end touch point and the second end touch point is less than 1.

10. The method of claim 8, wherein determining the scaling gesture further comprises:
determining a scaling down gesture in an instance in which the first area is larger than the second area; and
determining a scaling up gesture in an instance in which the second area is larger than the first area.

11. The method of claim 8, wherein determining the scaling gesture further comprises:
determining a scaling factor that is associated with the difference between the first area and the second area.

12. The method of claim 8, further comprising:
determining a first distance between the first start touch point and the second start touch point;
determining a second distance between the first end touch point and the second end touch point;
comparing the first distance to the second distance; and
determining a scaling gesture according to the comparison result.

13. The method of claim 1, wherein detecting one or more induction signals comprises detecting at least one of a change in electrical current, capacitance, acoustic waves, electrostatic field, optical fields or infrared light.

14. A device of identifying a scaling gesture comprising:
a detecting module, configured to detect one or more induction signals induced by one or more pointing objects that come into contact with a touch-sensitive surface;
a determination module, configured to determine the number of pointing objects;
a scaling gesture determining module, configured to determine a scaling gesture performed by the pointing objects;
a signal generation module, configured to generate a control signal associated with the determined scaling gesture; and
a processing unit, configured to execute a scaling command in response to the generated control signal.

15. The device of claim 14, wherein the determination module further comprises:
a comparing unit, configured to compare values of selected points of the detected induction signal to a reference signal to determine the number of a rising wave and the number of a falling wave; and
a number determining unit, configure to determine the number of pointing objects that generate the induction signals according to the number of the rising wave and the falling wave.

16. The device of claim 15, wherein the comparing unit further comprises:
comparing values of two adjacent points to a reference signal to determine a rising wave or a falling wave; and
determining the number of rising waves and/or falling waves to determine the number of pointing objects.

17. The device of claim 15, wherein the determination module is configured to:
identify one or more rising points on the rising wave intercepted by the reference signal;
identify one or more drop points on the falling wave intercepted by the reference signal; and
compare a distance between a rising point and a subsequent drop point to a predetermined threshold value or comparing a distance between a drop point and a subsequent rising point to a predetermined threshold value to determine if the detected induction signal is induced by a valid contact.

18. The device of claim 15, wherein the detecting module configured to detect a change in at least one of electrical current, capacitance, acoustic waves, electrostatic field, optical fields and infrared light.

19. The device of claim 14, wherein the detecting module comprises:
a transmitting transducer, configured to convert an electrical signal into an acoustic signal and emit the acoustic signal to a reflector; and
a receiving transducer, configured to receive the acoustic signal from the reflector, convert the acoustic signal into a second electrical signal and send the second electrical signal to the processing unit.

20. The device of claim 14, wherein the scaling gesture determining module further comprises:
a variation determination unit, configured to obtain coordinates of a first start touch point and a first end touch point associated with a first pointing object, and a second start touch point and a second touch end point associated with a second pointing object; and
a scaling gesture determination unit, configured to determine a scaling gesture based on the obtained coordinates.

21. The device of claim 20, wherein the variation determination unit is configured to:
obtain a first area of a first rectangular with the first start touch point and the second start touch point on diagonal corners of the first rectangular;
obtain a second area of a second rectangular with the first end touch point and the second end touch point on diagonal corners of the second rectangular; and
compare the first area to the second area; and
determine a scaling gesture based on the comparison result.

22. The device of claim 21, wherein the variation determination unit is configured to set the difference to 1 in an instance in which difference between coordinates in one direction between the first start touch point and the second start touch point is less than 1 or difference between coordinates in one direction between the first end touch point and the second end touch point is less than 1.

23. The device of claim 21, wherein the scaling gesture determination unit is configured to:
determine a scaling down gesture in an instance in which the first area is larger than the second area; and
determine a scaling up gesture in an instance in which the second area is larger than the first area.

24. The device of claim 21, wherein the scaling gesture determination unit is configured to determine a scaling factor that is associated with the difference between the first area and the second area.

25. The device of claim 21, wherein the variation determination unit is configured to:
determine a first distance between the first start touch point and the second start touch point;
determine a second distance between the first end touch point and the second end touch point;
compare the first distance to the second distance; and
determine a scaling gesture according to the comparison result.
